(19) United States
(12) Patent Application Publication
(10) Pub. No.: US 2008/0228643 A1
(43) Pub. Date: Sep. 18, 2008

(54) System and method for payment of consumer purchases via vendor escrow accounts

(76) Inventor: Arthur W. Hall, New York, NY (US)

Correspondence Address: Cheryl F. Cohen, LLC, 2409 Church Road, Cherry Hill, NJ, 08002, US

(21) Appl. No.: 11/724,999

(22) Filed: Mar. 16, 2007

(51) Int. Cl. G06Q 40/00

(52) U.S. Cl. 705/40

(57) ABSTRACT

A system and method for payment by a consumer of a purchase from one of a plurality of participating vendors. Each product or service for purchase is classified by a central office into a unique class. A single vendor is permitted for each class of product or service thereby guaranteeing a maximum return of investment. The consumer establishes a vendor escrow account, wherein each vendor escrow accounts is associated with a specific participating vendor. In advance of the purchase, a predetermined amount of funds, as specified by the consumer, is diverted from their paycheck into the vendor escrow account and prohibited thereafter from withdrawal by the consumer. Appropriate funds are debited from the vendor escrow account in payment for the purchase made by the consumer from the associated participating vendor.

### BACKGROUND OF THE INVENTION

1. Field of the Invention

The present invention is directed to a system and method for payment of consumer purchases of goods and/or services and, in particular, to a system and method for consumers to pay for their purchases of products and/or services by allocating a portion of their funds to be directed to escrow accounts targeted to participating vendors.

2. Description of Related Art

In today's society consumers consistently rank convenience as one of their highest priorities. It is therefore no surprise that a great deal of focus and attention has been recently directed to offering more and more services via the consumer's workplace. Direct deposit of an employee's payroll check into their bank account is one convenience offered by most employers today to their employees. Another option provided by employers to their employees that is becoming more available is payroll deduction for consumer purchases made by an employee. For example, U.S. Pat. No. 7,024,389 discloses a system and method for using a payroll deduction card as a payment instrument whereby a purchase price of articles purchased on-line or off-line is deducted from an employee's paycheck using an e-duction card.

This patented system provides the employee with an alternative payment option from that of conventional debit cards, credit cards, checks or cash. However, such a system will only be practical if it is available on a widespread basis. No economic or financial incentive exists on the part of the vendor to offer payroll deduction as a payment option since payment for the article being purchased is received by the vendor regardless of the method of payment selected. Therefore, the vendor's sole impetus for agreeing to such an arrangement is convenience on the part of the consumer purchaser.

In today's competitive global economy it is imperative that the vendor secure a portion of the marketplace and invest wisely in those marketing tools that provide the greatest return on their initial investment. To further this effort companies often offer reward programs whereby additional benefits are dispensed based on spending habits. For example, credit card companies offer reward systems such as cash back or bonus points whereby benefits are disbursed based on the consumer's spending habits. By their overwhelming acceptance vendors have demonstrated the value of such reward programs as effective marketing tools.

However, such reward programs are based on past rather than future spending. Thus, there is no way for the vendor to predict, in advance, the future spending habits of the consumer with any degree of certainty. Since the reward program is based on past spending habits, it is possible that the vendor may realize only a relatively low rate of return on their investment if the consumer's spending habit does not increase. Accordingly, such a conventional reward program based on past spending habits provides at best a relatively unpredictable rate of return on the vendor's initial investment.

It is therefore desirable to combine a payment system convenient for the consumer with a reward system that realizes a high yield of return on the vendor's investment based on future consumer spending habits.

### SUMMARY OF THE INVENTION

It is therefore an object of the present invention to develop a system and method for providing consumers a convenient method for payment for purchased items.

Another object of the present invention is to develop a system and method for ensuring payment of consumer purchases without the need for collection.

Still another object of the invention is to develop a payment system whereby the participating vendors realize a relatively high return on their investment.

Yet another object of the invention is develop a payment system whereby vendors are able to issue rewards or incentives to participating consumers based on their future spending habits that are ascertained in advance.

One aspect of the present invention is directed to a method for payment by a consumer of a purchase from one of a plurality of participating vendors. Each product or service for purchase is classified by a central office into a unique class. A single vendor is permitted for each class of product or service thereby guaranteeing a maximum return of investment. The consumer establishes a vendor escrow account, wherein each vendor escrow accounts is associated with a specific participating vendor. In advance of the purchase, a predetermined amount of funds, as specified by the consumer, is diverted from their paycheck into the at least one vendor escrow account and prohibited thereafter from withdrawal by the consumer. Appropriate funds are debited from the at least one vendor escrow account in payment for the purchase made by the consumer from the associated participating vendor.

The invention is also directed to a system for carrying out the method described in the preceding paragraph. In accordance with the invention, the system includes an input device to establish at least one vendor escrow account at the consumer's request. Each vendor escrow account is associated with one of the at least one participating vendors. The input device receives from the consumer a predetermined amount of funds to be diverted into each of the at least one vendor escrow accounts, wherein funds received in each of the at least one vendor escrow accounts are restricted to payment of purchases sold by the participating vendor associated with that vendor escrow account. Furthermore, the system also includes a central processor that receives from the input device the predetermined amount of funds specified by the consumer to be diverted into each of the at least one vendor escrow accounts. In advance of any purchase, the central processor transfers the funds into each of the at least one vendor escrow accounts based on the received predetermined amount of funds entered by the consumer using the input device. Thereafter, the central processor debits the vendor escrow account for the purchase made by the consumer from the associated participating vendor. Communication between the input device and central processor is provided over a network.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1 is an exemplary high-level schematic diagram of a system for payment of purchases via escrow accounts targeted to participating vendors in accordance with the present invention; and

FIG. 2 is an exemplary flow diagram of the operation of the method of using the system in FIG. 1.

### DETAILED DESCRIPTION OF THE PRESENTLY PREFERRED EMBODIMENTS OF THE INVENTION

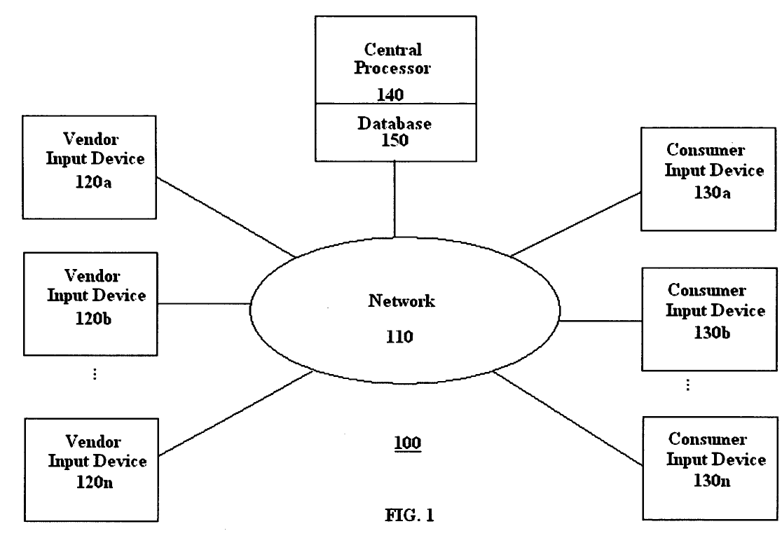

The present invention is directed to a system and method for payment of consumer purchases via escrow accounts targeted to participating vendors. FIG. 1 is an exemplary high-level schematic diagram of the payment system 100 in accordance with the present invention. Participants communicate via a network 110 for exchanging data or transacting business such as the Internet, an intranet, an extranet, wide area network (WAN), local area network (LAN), Public Switched Telephone Network (PSTN) or satellite communications. The users or participants (vendors and consumers) may interact in the system via any input device or terminal 120, 130 such as a personal computer, network computer, workstation, minicomputer, mainframe, kiosk, personal digital assistant (PDA), handheld or mobile computer (e.g., Palm Pilot®) or mobile telephone. A consumer that participates or subscribes to the payment system in accordance with the present invention is provided the option of paying for their consumer purchases by diverting, allocating or targeting a portion of their funds to one or more vendor escrow accounts in advance of future purchases. The present invention is shown and described in the context of an employment relationship whereby the employer subscribes to the payment system as a convenience to their employees. Those employees that choose to participate in the program divert a portion of their paycheck to one or more vendor escrow accounts to pay for purchases of products and/or services offered by vendors associated with such accounts. The system in accordance with the present invention, however, is not limited to an employer-employee relationship. Consumers may choose to participate in the inventive program directly or indirectly through other existing relationships such as banks and their account holders.

As shown in FIG. 1, any number of one or more consumers may choose to participate in the system using consumer input devices or terminals 130a, 130b, . . . , 130n. One or more vendors are also solicited by a central office, central processor, server or hub 140 to participate in the reward and payment system. The vendors interact with the system via vendor input devices or terminals 120a, 120b, . . . 120n. Regardless of the fact that consumer input devices are shown separate from those of vendor input device in FIG. 1, the same input devices can be used by both vendor and consumers alike. A database 150 associated with the central processor 140 stores information concerning participating consumers, participating vendors and vendor escrow accounts established by each consumer. In addition, the database 150 stores necessary programming software and information concerning credit and debit of respective vendor escrow accounts accordingly as updated by the central processor 140 based on funds deposited by consumers into the respective vendor escrow accounts as well as purchases made by consumers of products and/or services offered by participating vendors.

Vendors are lured into participating in the system based on the substantially high rate of return on their investment. To maximize each vendor's return on their investment, in a preferred embodiment, the selection of participating vendors is restricted so that at any given time only a single vendor associated with a particular scope or classification of product or service is selected to participate in the program. The scope or classification of products and services may be defined, as desired, preferably by the central office 140. For example, in the case of utilities its scope or classification may be broadly defined to include both gas and electric. However, in those geographical areas in which one company provides gas while a different company is the source of electricity it may be beneficial to define such services more narrowly. For example, gas and electric may be classified or designated as two distinct services. Following this same example even further, conceivably gas could be further narrowed in scope to natural gas versus propane gas. Clearly, the classification of a particular product or service for which the number of participating vendors is restricted to only one directly depends on how the classification of the particular product or service is defined. Central office via central processor 140 may define the classification of a particular product or service, as desired. The definition of a particular classification may even differ geographically, for example, from one state to another.

An illustrative, non-exhaustive, list of exemplary classifications of products and services include: gasoline station; automotive repair shop; heating provider; clothing retailer; utilities provider; internet provider; cable provider; landline telephone service provider; mobile telephone service provider; beeper service provider; mortgage bank provider; car loan provider; child care/day care provider; dog walker/day care provider; retail grocery store, retail drug store; home improvement store; movie rental retailer; dining restaurant; travel agency; fitness center; newspaper store; magazine store; and movie theaters.

In a preferred embodiment, the central office via central processor 140 selects only a single vendor of a particular product or service to be a participant in the program. As previously noted above, since only a single vendor of a particular product or service is a participant all participating vendors will realize an optimum return on their investment. Configuring the system in such a manner to maximize the return on the vendor's investment will provoke competition among competitor vendors of a particular product or service thereby driving up the fee offered by a vendor in order to be selected to participate.

Despite the preference for the central office 140 selecting a single participating vendor of a particular product or service at any given time, an alternative arrangement is contemplated and within the intended scope of the present invention wherein more than one vendor of a particular product or service may participate. In accordance with this alternative approach, central office via central processor 140 may offer more than one vendor of a particular product or service to be a participant; however, at any given time the establishment or creation of an escrow account by a consumer 130 is restricted to a single vendor of a particular product or service in a classification. On the one hand, this alternative arrangement benefits the consumer by providing a greater selection among vendors; however, on the other hand, multiple participating vendors for a particular product or service potentially diminishes the return on each vendor's investment if the vendor is not selected by the consumer.

Each vendor is assessed by a the central office via central processor 140 a fee for participating in the program. Such a fee may be a membership or subscription fee that may be paid one time or on a periodic basis (e.g., monthly, quarterly, biannually or annually). This membership or subscription fee may increase substantially as vendors compete for the same product or service of the same classification to be selected by the central office as the participating vendor. In addition, the participating vendor is assessed a transactional fee with each purchase made by a participating consumer. Fees may be negotiated and vary by industry based on such factors as the varying percentage of profit in different industries. Administrative fees may also be assessed to cover such expenses as the cost of debit card services. The accumulated costs associated with participating in the present inventive system are still substantially less than conventional marketing and advertisement costs that have a significantly lower rate of return on the vendor's investment. Another offset to the expenses of the present system is the allocation of money in advance of any purchase allowing for immediate collection by the vendor without having to incur the costs for bill generation and uncollected accounts.

Vendor escrow accounts are preferably established for products and/or services purchased on a reoccurring basis, rather than a one time purchase. After the initial creation or establishment of one or more vendor escrow accounts the consumer requests that funds from their paycheck be diverted into a particular vendor escrow account for the payment of future purchases for products and/or services offered by that particular vendor. The portion or amount of funds diverted from the consumer's paycheck into each vendor escrow account is specified by the employee. In certain circumstances a regular or predetermined monthly fee paid to a vendor will be the same month after month. Some common regular or predetermined monthly fee payments include: a mortgage payment, house/apartment rental payment, car loan/lease payment and child care payment. Under such cases, the employee may specify that a predetermined amount to cover such fixed monthly payments be automatically and periodically (e.g., weekly, bi monthly, monthly, quarterly, bi-annually or annually) debited from their paycheck and deposited in the corresponding vendor escrow account. For instance, in the case of a fixed monthly mortgage payment, the corresponding funds may be automatically debited monthly from the employees paycheck and deposited in the escrow account of the bank holding the mortgage.

More often, however, the value of purchases of products or services provided by any one participating vendor will fluctuate. In such cases the employee may allocate a predetermined percentage (e.g., 1%) of their payroll check to be diverted to a particular vendor escrow account based on an overall estimated monthly budget for such expenses. This option provides the additional benefit of allowing the consumer to readily detect if their monthly expenses exceed their anticipated budget for any particular classification of product or service, e.g. groceries.

As still another option, the employee may set a predetermined monetary amount (e.g., $100) be targeted or diverted to a particular vendor escrow account. In contrast to the percentage of the overall payroll check which fluctuates with the employee's salary, the predetermined amount is specified by the consumer/employee.

In a preferred embodiment, once a portion of the employee's paycheck has been allocated or diverted to a particular vendor escrow account, the funds are only available for payment of products and/or services offered for sale by that particular vendor and purchased by the employee. The setting aside of funds only for a pre-chosen vendor provides a maximum return on the vendor's investment since all funds allotted to a particular vendor are guaranteed to be spent by the employee on products and/or services offered for sale by that vendor. However, consumers when not provided with an option of reclaiming funds once they have been targeted to a particular vendor escrow account often take a more conservative approach by reducing the size of their monetary contributions. To overcome such trepidation, the present inventive system may be modified to permit an employee to reclaim at least some portion, if not all, of their contribution of funds previously allocated to a pre-chosen vendor escrow account by paying a penalty (e.g., a predetermined fixed penalty or percentage penalty) and/or relinquishing of any rewards or incentives contributed by the vendor. Of course, the vendor under such an arrangement will not always receive the maximum return on their initial investment, but the system may be designed so that at worst they will not suffer any net loss from participating in the system.

Any form of incentive or reward may be offered by the vendor such as monetary contributions, coupons or additional discounts on products or services offered for sale by the vendor. Rewards or incentives issued by the vendor to the consumer may fluctuate based on at least one of the following factors: (i) the amount of funds diverted by the consumer into a escrow account of a particular vendor over a predetermined period of time; (ii) the amount of funds currently allocated by the consumer in an escrow account of a particular vendor; and/or (iii) the amount of purchases made by the consumer of products and/or services offered by a particular vendor over a predetermined period of time. To encourage more purchases on the part of the consumer, the vendor may offer a greater incentive or reward despite the fact that the consumer in the past has not made a significant number of purchases. Numerous other factors may be the basis for the vendor allocating rewards and incentives. Alternatively, the central office via central processor 140 may dictate the type of incentive or award to be offered by a participating vendor which may be the same for all vendors or differ depending on the particular industry of the vendor. In the case of matching monetary contributions the incentive or reward may be on a one-to-one basis or any other ratio based on the funds allocated by the consumer to a particular vendor escrow account. The central office via central processor 140 may also set the percentage matching contribution or a minimum percentage matching contribution to be offered by each participating vendor.

The rewards or incentives issued by participating vendors are preferably not affected by and thus may be combined with any other arrangements such as coupons, sale days or any other discounts offered to the general public at large. An expiration date may be assigned to any reward or incentive offered by a participating vendor to encourage additional purchases by the employee/consumer in a timely manner. In the case of a monetary contributions, coupons or discounts these incentives or rewards would have to be redeemed prior to the assigned expiration date.

Aside from rewards or incentives targeted to the participating members that have made contributions, the system provides vendors with pinpoint marketing opportunities to distribute information for release of new products and/or services being offered, promotions, new locations and an ideal targeted audience to conduct surveys to better serve their customer base. In the case of direct advertising to the participating consumers a fee may be assessed by the central office via central processor 140 on a per distribution basis. This fee would be analogous to the fee incurred in the credit card industry for bill stuffers. A larger fee could be assessed on a per distribution basis for the present invention in comparison with conventional bill stuffers since the rate of return on the vendor's investment is significantly greater.

After establishing the escrow account for a particular vendor and making the desired transfer into the associated account, the consumer is free to purchase products and services offered by that particular vendor. In a preferred embodiment, the purchase is made by the employee using a debit card at the point of purchase or over the Internet. If the total allocated funds in the escrow account are exceeded by the purchase, any excess charges will flow through a standard debit card model.

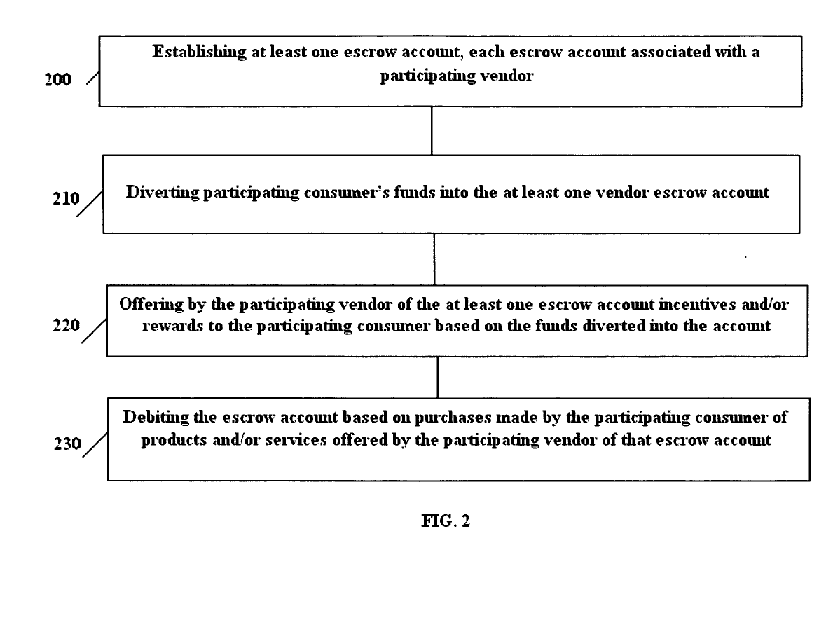

FIG. 2 is an exemplary flow chart of the operation of the payment system in accordance with the present invention. In step 200 the consumer establishes or creates at least one escrow account, wherein each account is associated with a participating vendor. In advance of any purchase the consumer diverts, allocates or targets funds into the at least one vendor escrow account in step 210. In the case of an employment relationship, the employee may request that their employer divert the finds from their paycheck into the specified vendor escrow accounts. Once deposited or diverted into a particular vendor escrow account thereafter such funds preferably are not subject to later withdrawal or transfer by the consumer. Based on the allocation of funds into their associated escrow account, the participating vendor may issue rewards or incentives to the participating consumer, as described in step 220. These rewards or incentives may take on many forms such as, but not limited to, matching monetary contributions into vendor escrow account established by the consumer. Finally, in step 230, purchases made by participating consumers for products or services offered by any of the participating vendors are appropriately debited from the associated vendor escrow accounts based on the diverted funds made in advance by the participating consumer and any rewards or incentives offered by the participating vendors. It should be noted that such purchases may be made by a universal card or alternatively a particular vendor issued credit card in which the payroll deducted amounts have been appropriately credited to the consumer based on their funds deposited in the vendor escrow accounts and any other matching funds issued by the vendor.

The present inventive system and method has been described as being offered by employers to their employees. It is also contemplated and within the intended scope of the present invention for consumers to be invited to directly participate in the inventive system outside the scope of their employment. In this regard, the consumer funds would either be diverted from another account (e.g., checking account, saving account) or directly deposited for the first time (e.g., money or checks) into a particular vendor escrow account. Clearly there are advantages of convenience in diverting the funds via an employment relationship from the employee's paycheck, however, other relationships may serve as the background for offering consumers the option of participating in the present inventive payment system.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

Every issued patent, pending patent application, publication, journal article, book or any other reference cited herein is each incorporated by reference in their entirety.

What is claimed is:

1. A system for payment by a consumer of a purchase from at least one participating vendor, comprising:
an input device to establish at least one vendor escrow account at the consumer's request, each vendor escrow account being associated with one of the at least one participating vendors; the input device receiving from the consumer a predetermined amount of funds to be diverted into each of the at least one vendor escrow accounts, funds received in each of the at least one vendor escrow accounts are restricted to payment of purchases sold by the participating vendor associated with that vendor escrow account;
a central processor receiving from the input device the predetermined amount of funds specified by the consumer to be diverted into each of the at least one vendor escrow accounts; in advance of any purchase, processing the transfer of funds into each of the at least one vendor escrow accounts based on the received predetermined amount of funds entered by the consumer using the input device; and debiting the vendor escrow account for the purchase made by the consumer from the associated participating vendor; and
a network providing a communication link between the input device and central processor.

2. The system in accordance with claim 1, wherein the central processor classifies each product or service for purchase into a unique class and restricts participation among the plural participating vendors to a single vendor for each class of product or service.

3. The system in accordance with claim 1, wherein the central processor receives incentives from the at least one participating vendor to be transferred to the consumer based on the predetermined amount of funds diverted into the associated vendor escrow account as specified by the consumer.

4. The system in accordance with claim 3, wherein the incentive is matching funds transferred via the central processor from the at least one participating vendor into the associated vendor escrow account to be combined with the predetermined funds diverted by the consumer into the same vendor escrow account.

5. The system in accordance with claim 1, wherein the diverted predetermined funds in the vendor escrow accounts are prohibited from withdrawal by the consumer.

6. The system in accordance with claim 1, further comprising a debit card for payment of the purchase.

7. The system in accordance with claim 1, wherein the consumer is an employee employed by an employer and the funds are diverted from the employee's paycheck to the at least one vendor escrow account.

8. The system in accordance with claim 1, wherein the purchase may be for a product or a service.

9. A method for payment by a consumer of a purchase from one of a plurality of participating vendors comprising the steps of:
establishing at least one vendor escrow account, each of the at least one vendor escrow accounts being associated with one of the plurality of participating vendors;
in advance of the purchase, diverting a predetermined amount of funds as specified by the consumer into the at least one vendor escrow account; and
debiting appropriate funds from the at least one vendor escrow account in payment for the purchase made by the consumer from the associated participating vendor.

10. The method in accordance with claim 9, further comprising the step of issuing an incentive to the consumer by at least one of the plural participating vendors of the associated vendor escrow account based on the predetermined amount of funds diverted into the associated vendor escrow account as specified by the consumer.

11. The method in accordance with claim 9, wherein the consumer is an employee employed by an employer and the funds are diverted from the employee's paycheck into at least one of the vendor escrow accounts.

12. The method in accordance with claim 9, wherein once diverted into the vendor escrow account thereafter the predetermined funds are prohibited from withdrawal by the consumer.

13. The method in accordance with claim 10, wherein the issuing of incentives comprises matching monetary contributions by the vendor deposited into the vendor escrow account based on the predetermined amount of funds diverted to the same vendor escrow account by the consumer.

14. The method in accordance with claim 9, wherein the purchase may be for a product or a service.

15. The method in accordance with claim 13, wherein the matching monetary contributions by the vendor are deposited in the vendor escrow account to be combined with the predetermined funds diverted by the consumer into the vendor escrow account.

16. The method in accordance with claim 9, wherein the funds in the vendor escrow account are applied exclusively to the payment of purchases sold by the associated participating vendor.

17. The method in accordance with claim 9, prior to the establishing step, further comprising classifying each product or service for purchase into a unique class and restricting participation among the plural participating vendors to a single vendor for each class of product or service.

18. A method for payment by a consumer of a purchase from one of a plurality of participating vendors comprising the steps of:
classifying each product or service for purchase into a unique class and restricting participation among the plural participating vendors to a single vendor for each class of product or service;
establishing at least one vendor escrow account, each of the at least one vendor escrow accounts being associated with one of the plurality of participating vendors;
in advance of the purchase, diverting a predetermined amount of funds as specified by the consumer from their paycheck into the at least one vendor escrow account; once diverted into the vendor escrow account thereafter the predetermined amount of funds are prohibited from withdrawal by the consumer;
issuing a matching monetary contribution to the consumer by at least one of the plural participating vendors of the associated established vendor escrow account based on the predetermined amount of funds diverted into the associated vendor escrow account as specified by the consumer; and
debiting appropriate funds from the at least one vendor escrow account in payment for the purchase made by the consumer from the associated participating vendor.
